(19) United States
(12) Patent Application Publication
(10) Pub. No.: US 2017/0337081 A1
(43) Pub. Date: Nov. 23, 2017

(54) CENTRALIZED PROCESSING FOR AIRCRAFT OPERATIONS

(71) Applicant: Sikorsky Aircraft Corporation, Stratford, CT (US)

(72) Inventors: Igor Cherepinsky, Sandy Hook, CT (US); Daniel Dellaripa, Wallingford, CT (US); Christopher A. Thornberg, Newtown, CT (US); Gary Howland, Stratford, CT (US)

(21) Appl. No.: 15/525,746

(22) PCT Filed: Nov. 12, 2015
(86) PCT No.: PCT/US15/60322

§ 371 Date: May 10, 2017

Related U.S. Application Data
(60) Provisional application No. 62/078,658, filed on Nov. 12, 2014.

(51) Int. Cl. G06F 9/48; B64C 27/06; G05B 15/02; G06F 9/50

(52) U.S. Cl. CPC G06F 9/4881; G06F 9/5083; B64C 27/06; G05B 15/02

(57) ABSTRACT

A system for centralizing computing operations for an aircraft, including a plurality of aircraft subsystems associated with the aircraft, a plurality of aircraft sensors associated with the aircraft, and a centralized processor to process the computing operations requested by each of the plurality of aircraft subsystems.

### FIELD OF THE INVENTION

The subject matter disclosed herein relates to computing operations in an aircraft, and to a system and a method for centralizing computing operations from a plurality of aircraft subsystems.

### DESCRIPTION OF RELATED ART

Typically, modern aircraft, e.g. a helicopter, require parameters to be monitored and operations to be completed during flight. For example, the cockpit system, main rotor system, tail system, propulsion system, landing gear system, fire extinguisher system, and mission system all require parameters to be monitored and operations to be performed. Further, such operations and parameters allow enhanced user information, flight capabilities and safety.

Aircraft sensing and computing subsystems are often federated by their function. These subsystems traditionally utilize independent processors and sensors to perform designated functions and operations. These subsystems often utilize redundant sensors and independent processors, adding additional weight, additional power, and additional heat within an aircraft. A system and method that can centralize computing operations from a plurality of aircraft subsystems is desired.

### BRIEF SUMMARY

According to an embodiment of the invention, a system for centralizing computing operations for an aircraft includes a plurality of aircraft subsystems associated with the aircraft, a plurality of aircraft sensors associated with the aircraft, and a centralized processor to process the computing operations requested by each of the plurality of aircraft subsystems.

In addition to one or more of the features described above, or as an alternative, further embodiments could include that the centralized processor is further configured to selectively sample at least one of the plurality of aircraft sensors.

In addition to one or more of the features described above, or as an alternative, further embodiments could include that the centralized processor is a plurality of associated processors.

In addition to one or more of the features described above, or as an alternative, further embodiments could include a scheduler to prioritize the computing operations requested by each of the plurality of aircraft subsystems.

In addition to one or more of the features described above, or as an alternative, further embodiments could include that the plurality of aircraft sensors bypass the scheduler.

In addition to one or more of the features described above, or as an alternative, further embodiments could include that at least one of the aircraft subsystems of the plurality of aircraft subsystems is a virtual subsystem.

In addition to one or more of the features described above, or as an alternative, further embodiments could include that a digital communication network facilitates communication between the plurality of aircraft subsystems.

In addition to one or more of the features described above, or as an alternative, further embodiments could include that the centralized processor redistributes the computing operations.

According to an embodiment of the invention, a method for centralizing computing operations in an aircraft, including providing a plurality of aircraft subsystems associated with the aircraft, providing a plurality of aircraft sensors associated with the aircraft, requesting at least one computing operation via at least one of the plurality of aircraft subsystems, and processing the at least one computing operation via a centralized processor.

In addition to one or more of the features described above, or as an alternative, further embodiments could include selectively sampling at least one of the plurality of aircraft sensors via the centralized processor.

In addition to one or more of the features described above, or as an alternative, further embodiments could include that wherein the centralized processor is a plurality of associated processors.

In addition to one or more of the features described above, or as an alternative, further embodiments could include prioritizing the at least one computing operation via a scheduler.

In addition to one or more of the features described above, or as an alternative, further embodiments could include that at least one of the aircraft subsystems of the plurality of aircraft subsystems is a virtual subsystem.

In addition to one or more of the features described above, or as an alternative, further embodiments could include that a digital communication network facilitates communication between the plurality of aircraft subsystems.

In addition to one or more of the features described above, or as an alternative, further embodiments could include that the centralized processor redistributes the computing operations.

Technical function of the embodiments described above includes centralizing processing of the computing operations of a plurality of subsystems and scheduling the computing operations to be performed by the centralized processor.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a schematic isometric view of an aircraft in accordance with an embodiment of the invention;

FIG. 2 illustrates a schematic view of an exemplary computing system in accordance with an embodiment of the invention; and

FIG. 3 is a flow diagram of a method of centralizing computing operations in accordance with an embodiment of the invention.

### DETAILED DESCRIPTION OF THE INVENTION

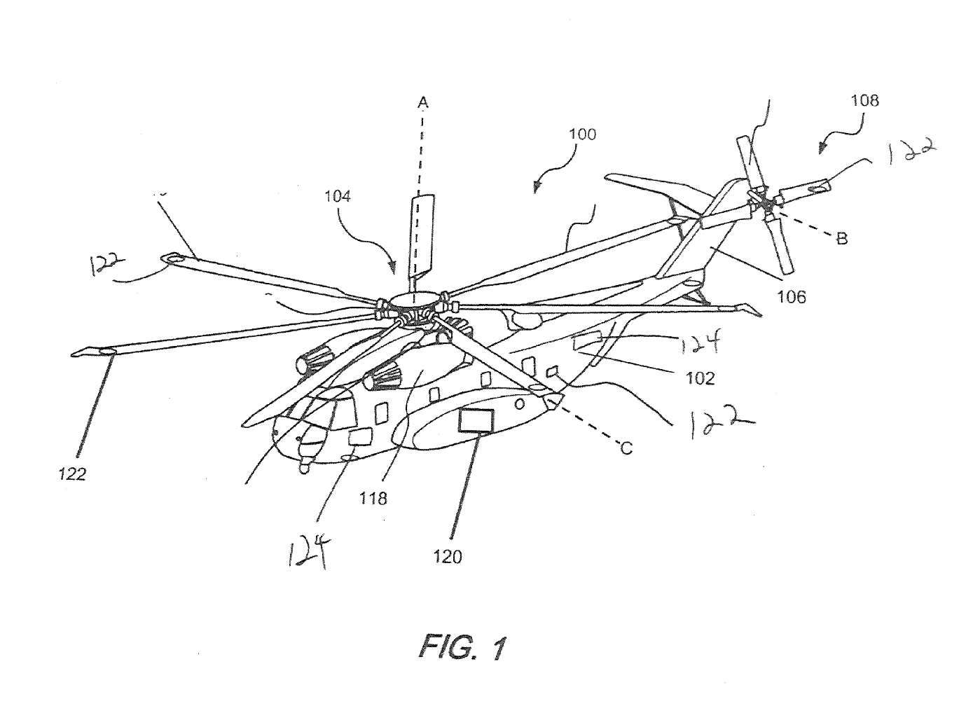

Referring now to the drawings, FIG. 1 illustrates a general perspective view of an exemplary vehicle in the form of a vertical takeoff and landing (VTOL) rotary-wing helicopter or aircraft 100 for use with a centralized processing system in accordance with an embodiment of the invention. In an embodiment, aircraft 100 is an optionally piloted vehicle and can autonomously perform required aircraft computing operations as it traverses a flight plan. Aircraft 100 includes an airframe 102, a plurality of aircraft subsystems 124, a plurality of sensors 122, and a centralized processing system 120.

Airframe 102 of aircraft 100 includes a main rotor 104, an extending tail 106 which mounts an anti-torque system, such as a tail rotor 108. Main rotor 104 and tail rotor 108 are driven to rotate by one or more engines 118 through one or more gearboxes (not shown).

Aircraft subsystems 124 of aircraft 100 perform, control, and generally include the above described aircraft components as well as other aircraft components and functions of aircraft 100. A plurality of aircraft subsystems 124 may be disposed throughout the aircraft 100 to perform aircraft functions in response to operating conditions and user input. Aircraft subsystems 124 may include, but are not limited to: cockpit systems, main rotor/QCA accessories, tail system, propulsion, landing gear, fire extinguisher, mission system, etc. Aircraft subsystems 124 often require computing operations to be performed to allow for desired operations. Often, aircraft subsystems 124 require the input of one or more sensors 122 for feedback and operation parameters.

A plurality of sensors 122 are disposed throughout the aircraft 100 for monitoring of inflight parameters including environmental conditions, operating conditions, user input, etc. Such sensors 122 may provide information and feedback to aircraft subsystems 124. Such sensors 122 may include, but are not limited to strain gauges, magnetic Hall Effect sensors, temperature sensors, pressure sensors, magnetorestrictive sensors, accelerometers, and rate gyros. In an exemplary embodiment, data from sensors 122 may be utilized by more than one subsystem 124.

A centralized processing system 120 allows for central processing of operations of subsystems 124 and sampling of sensors 122. Centralized processing system 120 is a smart system disposed within the aircraft 100. Centralized processing system 120 allows for computing operations requested by multiple aircraft subsystems 124 to be performed centrally, removing the need for separate discrete processors and offloading processing demands. Further, centralized processing system 120 may sample and query aircraft sensors 122, preventing redundant sensors for each subsystem 124, reducing weight, cost and complexity. Such a centralized processing system allows for resources to be shared to reduce redundancy, increase system reliability, allow for cross subsystem communication, increase equipment utilization, and reduce weight, energy consumption, and operating temperatures.

Although a particular helicopter is illustrated and described in the disclosed embodiment, it will be appreciated that other configurations and/or machines including autonomous and optionally piloted aircraft that may operate in land or water including fixed-wing aircraft, rotary-wing aircraft, and land vehicles (e.g., trucks, cars, etc.) may also benefit from embodiments disclosed.

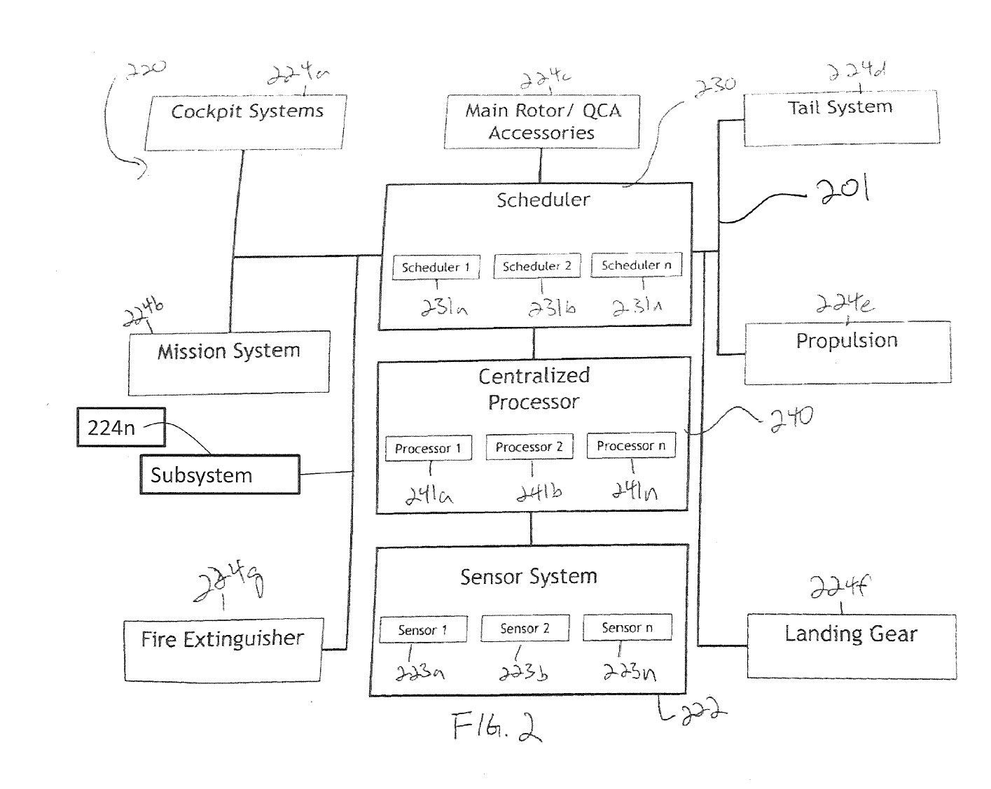

As illustrated in FIG. 2, multiple subsystems 224a-224n are connected to a centralized processor 240 in system 220 to allow centralized aircraft operations. In exemplary embodiments, subsystems 224a-224n are connected to a centralized processor 240 via a scheduler 230. Further, in certain embodiments, sensor system 222 is directly connected to centralized processor 240, bypassing scheduler 230.

In certain embodiments, the network connecting subsystems 224a-224n with centralized processor 240 and other elements of the system shown in FIG. 2 is a digital communication network 201. In an exemplary embodiment, digital communication network 201 is redundant, high speed, and time deterministic. Further, digital communication network 201 allows data to be available to all elements of the system shown in FIG. 2. In conjunction with centralized processor 240 and scheduler 230, data between system elements may be time synchronized. In certain embodiments, latencies are minimized by providing adequate loop closure. In an exemplary embodiment, digital communication network 201 includes redundant busses. Advantageously, the use of redundant busses instead of dedicated interfaces reduces overall component weight. Further, digital communication network 201 allows for software or subsystem 224n additions without affecting the physical structure of digital communication network 201.

Subsystems 224a-224n may include, but are not limited to, cockpit system 224a, mission system 224b, main rotor/QCA accessories 224c, tail system 224d, propulsion 224e, landing gear 224f and fire extinguisher 224g. Cockpit system 224a may include components including, but not limited to, cockpit pedals, cockpit brakes, cockpit switches, engine controls, fire suppression controls, etc. Mission system 224b may include components including, but not limited to, mission planning components, etc. Main rotor/QCA accessories 224c may include components including, but not limited to, hydraulic systems, servos, electrical components, anti-vibration control force generator, etc. Tail system 224d may include components including, but not limited to, rudder and elevator servos, prop pitch servo and prop cyclic servo, etc. Propulsion system 224e may include components including, but not limited to, engines, auxiliary power unit, etc. Landing gear system 224f may include components including, but not limited to, gear retractor actuator, brake actuators, etc. Fire extinguisher system 224g may include components including, but not limited to, fire bottles, etc.

In an exemplary embodiment, subsystems 224a-224n are physically discrete systems. In certain embodiments, as later discussed, centralized processor 240 can create logical virtual subsystems corresponding to traditional subsystems of an aircraft 100. Subsystems 224a-224n may contain components that include, but are not limited to health management systems, active vibration control systems, and optionally piloted vehicle systems.

Before, during and after aircraft 100 operation, subsystems 224a-224n perform functions required by the user and aircraft. These functions often require computing operations that are requested by subsystems 224a-224n. In an exemplary embodiment, centralized processor 240 may request operations to be performed by subsystems 224a-224n. In certain embodiments, subsystems 224a-224n are generally managed by centralized processor 240 and scheduler 230.

During aircraft operations, subsystems 224a-224n often require information about user input and aircraft states available from sensor system 222. Sensor system 222 includes sensors 223a-223n, including but not limited to air data sensors, exhaust gas information sensors, long range LIDAR, long range SWIR, long range video, short range LIDAR, short radar, accelerometers, transmission sensors, weight on wheels sensors, strain gauges, magnetic Hall Effect sensors, temperature sensors, pressure sensors, magnetorestrictive sensors, accelerometers, and rate gyros.

Advantageously, the use of a centralized processor 240 allows for a common set of sensors 222 to provide information needed for subsystems 224a-224n without any redundant sensors.

In exemplary embodiments, scheduler 230 is a time based scheduler to prioritize the operations requested by subsystems 224a-224n. During aircraft operation, often numerous processing operations are requested by subsystems 224a-224n requiring operations to be prioritized before issuing requests to the central processors. In an exemplary embodiment, multiple schedulers 231a-231n are utilized. In certain embodiments, certain schedulers 231a-231n are associated with specific subsystems 224a-224n. In other embodiments, certain schedulers 231a-231n are associated with specific processors 241a-241n. In exemplary embodiments, schedulers 231a-231n prioritize tasks and assign specific processors 241a-241n to specific tasks. In exemplary embodiments, sensor system 222 bypasses scheduler 230 to be directly connected to centralized processor 240. In other embodiments, sensor system 222 utilizes scheduler 230. Advantageously, scheduler 230 allows for time scheduling of previously non-committing devices, allowing efficient resource allocation.

Centralized processor 240 allows for computing operations to be performed in a centralized location to simplify and enhance aircraft operations with fewer processors to manage. In an exemplary embodiment, centralized processor 240 contains multiple processors 241a-241n. In certain embodiments, the number of processors 241a-241n is extensible depending on operation requirements. As prioritized instructions are received by scheduler 230, centralized processor 240 (or assigned processor 241a-241n) performs the required task and sends the determined signals back to the subsystems 224a-224n. In certain embodiments, the determined control signals as a result of processor 240 operations are sent through scheduler 230.

Often, computing operations require sensor input from sensor system 222. In certain embodiments, the sensor system 222 is connected via a specialized high speed bus that bypasses the scheduler 230 to allow high priority access to sensor system 222 via centralized processor 240. The use of centralized processor 240 removes the need for redundant and federated processors, which may often be idle, compared to the centralized processor 240 which is scheduled, prioritized and optimized by scheduler 230.

Scheduler 230 and centralized processor 240 may work in conjunction to logically or virtually create subsystems in software. If a functional or user designated aspect of aircraft operations is identified, that system can be assigned a priority by the scheduler, evaluated and utilized. In an exemplary embodiment, scheduler 230 and centralized processor 240 have the ability to reconfigure and redistribute processing resources in response to system demands, scheduled maintenance and failures, including processor 240 failures. In certain embodiments, critical tasks performed by processor 240 are identified, allowing critical tasks to be redistributed to another processor 241a-241n in the event of failure, or any other suitable scenario. Further, scheduler 230 and centralized processor 240 may work in conjunction to dynamically re-allocate processing responsibilities to facilitate balancing and redundancy of critical tasks to maintain (critical and non-critical processing tasks) to achieve high level objectives.

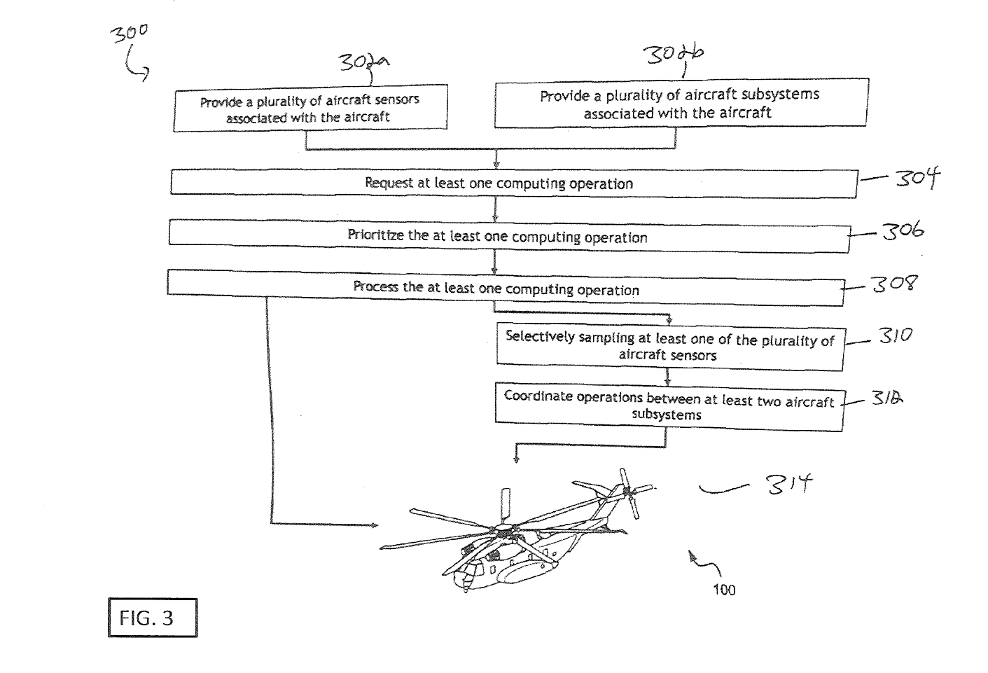

FIG. 3 illustrates a method for centralizing processing operations for an aircraft. In operations 302a and 302b a plurality of aircraft subsystems 224a-224n and a plurality of aircraft sensors 223a-223n are provided within the aircraft 100. In certain embodiments, the network connecting subsystems 224a-224n with centralized processor 240 and other elements of the system is the digital communication network 201. In an exemplary embodiment, digital communication network 201 is redundant, high speed, and time deterministic.

In operation 304 at least one subsystem 224n requests that a computing operation is performed or is required to be performed. Such requests may be prompted or triggered by the centralized processor 240, time, an event, a user input, or in reaction to an aircraft or environmental condition. In operation 306 the requests from subsystems 224a-224n are prioritized, routed to specific processors 241a-241n, and scheduled by the at least one scheduler 230. This operation allows for load and resource management and distribution, prioritization for essential and high priority subsystems and actions. In an exemplary embodiment, scheduler 230 and centralized processor 240 have the ability to reconfigure and redistribute processing resources, in addition to prioritization, in response to system demands, scheduled maintenance and failures, including processor 240 failures.

In operation 308 the requested operation is processed by centralized processor 240. Centralized processor 240 may perform complex computational operations, query sensor system 222, communicate with other subsystems 224a-224n, or otherwise perform functions that traditionally would be performed by an individual subsystem processor. Advantageously, the use of a smart system as described allows for increased prioritization, utilization, simplification, and efficiency.

In operation 310, sensors 223a-223n are sampled or other systems are queried if required by the requested operation.

In operation 312, if any information or previous sensor readings need to be shared between requested operations and subsystems 224a-224n, the processor 240 sends the information to the appropriate subsystem 224n.

In operation 314, the processed information is passed on to the relevant subsystems 224a-224n and generally to the aircraft to allow for centralized operations.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. For instance, aspects of the invention are not limited to propeller blades for aircraft, and can be used in wind turbines and other systems with rotary elements. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A system for centralizing computing operations for an aircraft, comprising:
a plurality of aircraft subsystems associated with the aircraft;
a plurality of aircraft sensors associated with the aircraft; and
a centralized processor to process the computing operations requested by each of the plurality of aircraft subsystems.

2. The system of claim 1, wherein the centralized processor is further configured to selectively sample at least one of the plurality of aircraft sensors.

3. The system of claim 1, wherein the centralized processor is a plurality of associated processors.

4. The system of claim 1, further comprising a scheduler to prioritize the computing operations requested by each of the plurality of aircraft subsystems.

5. The system of claim 4, wherein the plurality of aircraft sensors bypass the scheduler.

6. The system of claim 1, wherein at least one of the aircraft subsystems of the plurality of aircraft subsystems is a virtual subsystem.

7. The system of claim 1, wherein a digital communication network facilitates communication between the plurality of aircraft subsystems.

8. The system of claim 1, wherein the centralized processor redistributes the computing operations.

9. A method for centralizing computing operations in an aircraft, comprising:
providing a plurality of aircraft subsystems associated with the aircraft;
providing a plurality of aircraft sensors associated with the aircraft;
requesting at least one computing operation via at least one of the plurality of aircraft subsystems; and
processing the at least one computing operation via a centralized processor.

10. The method of claim 9, further comprising selectively sampling at least one of the plurality of aircraft sensors via the centralized processor.

11. The method of claim 9, wherein the centralized processor is a plurality of associated processors.

12. The method of claim 9, further comprising prioritizing the at least one computing operation via a scheduler.

13. The method of claim 9, wherein at least one of the aircraft subsystems of the plurality of aircraft subsystems is a virtual subsystem.

14. The method of claim 9, wherein a digital communication network facilitates communication between the plurality of aircraft subsystems.

15. The method of claim 9, wherein the centralized processor redistributes the computing operations.
